(19) United States
(12) Patent Application Publication
(10) Pub. No.: US 2012/0119920 A1
(43) Pub. Date: May 17, 2012

(54) PORTABLE SENSORY DEVICES

(75) Inventors: Ben Sallop, Austin, TX (US); Janna K. Lippman, Houston, TX (US)

(73) Assignee: EXTRA SENSORY TECHNOLOGY, L.C., Houston, TX (US)

(21) Appl. No.: 12/945,463

(22) Filed: Nov. 12, 2010

(51) Int. Cl. G08B 6/00

(52) U.S. Cl. 340/686.6

(57) ABSTRACT

A portable sensory device may be a portable object including a portable sensory system. The portable object may be a walking cane or an item of clothing. The portable sensory system may include a proximity sensor configured to generate an output signal in response to detecting an object in a predetermined sensory range, such as a solid angle. The portable sensory system may further include a sensory actuator, to which a control signal is sent to generate user feedback in response to the output signal provided by the proximity sensor. In this manner, sensory information associated with specific visual information for the sensory range may be provided to the user.

### BACKGROUND

1. Field of the Disclosure

The present disclosure relates to sensory devices and, specifically, to portable sensory devices with sensory user feedback.

2. Description of the Related Art

Sensory devices may communicate information to a user about the user's environs. Certain users with sensory disabilities may rely upon sensory devices to compensate for a loss or degradation of a natural sensory function. Typical sensory devices may be cumbersome to operate and may provide only limited information about objects in the user's environs.

### BRIEF DESCRIPTION OF THE DRAWINGS

FIG. 1 is a block diagram of selected elements of a portable sensory system;

FIG. 2 is a block diagram of selected elements of an embodiment of a portable sensory device;

FIG. 3 is a block diagram of selected elements of an embodiment of a portable sensory device;

FIG. 4 is a block diagram of selected elements of an embodiment of a portable sensory device;

FIG. 5 is a block diagram of selected elements of an embodiment of a portable sensory device;

FIG. 6 is a block diagram of selected elements of an embodiment of a portable sensory device;

FIG. 7 is a block diagram of selected elements of an embodiment of a portable sensory device;

FIG. 8 is a block diagram of selected elements of an embodiment of a portable sensory process; and

FIG. 9 is a block diagram of selected elements of an embodiment of a controller device.

### DESCRIPTION OF THE EMBODIMENT(S)

In one aspect, a disclosed method for communicating sensory information to a user includes receiving a signal from a proximity sensor indicating an object in a predetermined sensory range of the proximity sensor. Responsive to receiving the signal, the method may further include activating a haptic actuator associated with the predetermined sensory range. The proximity sensor and the haptic actuator may be contained in a portable object.

In some embodiments, the portable object may be a walking cane or an item of clothing worn by the user. The sensory range may be given by a first solid angle with respect to the proximity sensor. The proximity sensor and the haptic actuator may be included in a first sensory subsystem associated with the first solid angle, while the portable object contains a second sensory subsystem associated with a second solid angle different from the first solid angle. The haptic actuator may be configured to communicate with the user by generating a vibratory stimulation. The level of vibratory stimulation may be indicative of the predetermined sensory range.

In certain implementations, the proximity sensor may be configured to measure a distance from the object to the proximity sensor, while the method further includes varying a characteristic of the vibratory stimulation in response to the measured distance. The characteristic of the vibratory stimulation may be an amplitude, a frequency, or a combination thereof. The portable object may be configured for attachment to or inclusion within an item of clothing worn by the user.

In another aspect, a disclosed portable system for communicating sensory information includes at least two sensory subsystems. Each sensory subsystem may further include a controller, a proximity sensor configured to detect an object within a predetermined solid angle with respect to the proximity sensor, and a haptic actuator. Responsive to receiving a signal from the proximity sensor indicating the detected object, the controller may be configured to activate the haptic actuator. Each of the at least two sensory subsystems may be configured to detect an object in a different solid angle. The controller may include a control circuit coupled to the proximity sensor and the haptic actuator.

In particular embodiments, the portable system may further include a switch coupled to the control circuit and configured to activate or deactivate at least the haptic actuator. The haptic actuator may be configured to generate a vibratory stimulation. The proximity sensor may be configured to measure a distance of the detected object, while the controller may be further configured to vary a characteristic of the vibratory stimulation according to the distance of the object from the proximity sensor. The characteristic of the vibratory stimulation is at least one of an amplitude and a frequency. The portable system may be configured for attachment to or inclusion within an item of clothing worn by a user.

In yet another aspect, a disclosed portable sensory device includes a controller, a proximity sensor configured to detect an object within a predetermined solid angle with respect to the proximity sensor, and a sensory actuator. Responsive to receiving a signal from the proximity sensor indicating the detected object, the controller may be configured to activate the sensory actuator. The controller may include a control circuit coupled to the proximity sensor and the sensory actuator, while the portable sensory device may further include a switch coupled to the control circuit and configured to activate or deactivate at least the sensory actuator.

In some embodiments, the sensory actuator may be a haptic actuator that is configured to generate a vibratory stimulation, while the proximity sensor may be configured to measure a physical property of the detected object. The controller may further be configured to vary a characteristic of the vibratory stimulation according to the physical property, which may include a distance of the object from the proximity sensor, a color of the object, a physical dimension of the object, a shape of the object, a material included in the object, a relative motion of the object with respect to the proximity sensor, or a combination thereof. The portable sensory device may be configured for attachment to or inclusion within an item of clothing worn by a user. The portable sensory device may be included in an item of clothing worn by a user.

In given embodiments, the sensory actuator may be an acoustic output device that is configured to generate auditory signals.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

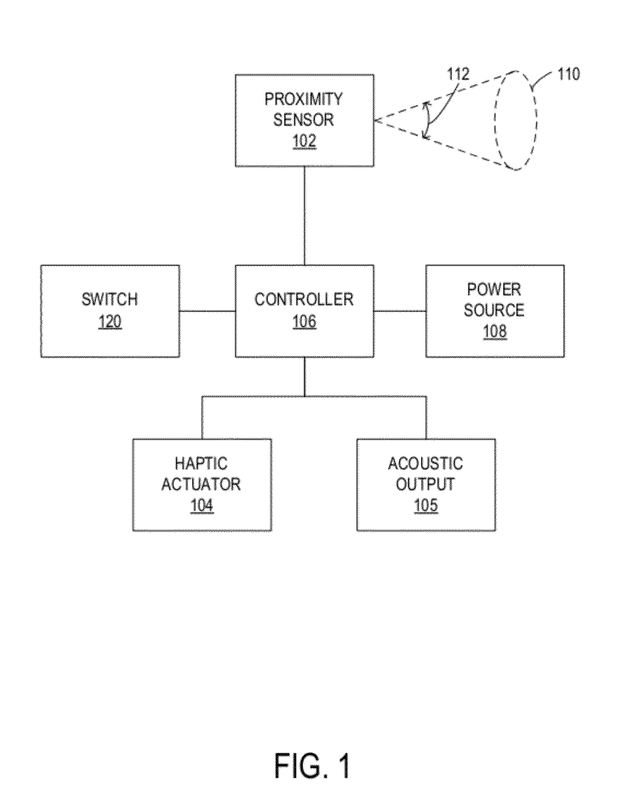

Turning now to the drawings, FIG. 1 is a block diagram of selected elements of portable sensory system 100. Portable sensory system 100, as shown, may represent components in a portable sensory device configured to be operated by a user to obtain sensory information describing the user's environs. Specifically, portable sensory system 100 may be configured to provide sensory information indicating objects in the vicinity of the user. In the case of an ambulatory user, portable sensory system 100 may provide sensory information about approaching objects. As will be described in detail below, portable sensory system 100 may be suitable for assisting a visually impaired user to obtain sensory information about the user's environs in substitution for visual information provided by the sense of sight.

As depicted in the exemplary embodiment of FIG. 1, portable sensory system 100 may comprise proximity sensor 102, haptic actuator 104, acoustic output 105, controller 106, power source 108, and switch 120. It is noted that in different embodiments, certain elements in portable sensory system 100 may be omitted, rearranged, adapted, or reconfigured, as desired. It is further noted that the relationship between elements depicted in FIG. 1 may be symbolic in nature and representative of various forms and types of physical and/or logical connections.

In FIG. 1, proximity sensor 102 may be any one or more of a different type of sensor that provides an output signal in response to a proximity of an external object (not shown in FIG. 1). The proximity of the object represents a distance between proximity sensor 102 and the object that may be greater than or equal to zero. Specifically, proximity sensor 102 may be configured to respond to objects within sensory range 110. Proximity sensor 102 may accordingly be configured with a predetermined setting for a specific value of sensory range 110. In general terms, sensory range 110 may define a solid angle with respect to portable sensory system 100 that subtends angle 112. Angle 112 may exhibit a wide range of values, while a center vector of sensory range 110 may point in a desired direction from proximity sensor 102. It is noted that sensory range 110 may define an arbitrary range with respect to an actual spatial sensitivity of proximity sensor 102. In certain instances, sensory range 110 may represent an outer limit for a region of acceptable spatial sensitivity to external objects provided by proximity sensor 102. In other embodiments, sensory range 110 may be electronically or physically limited to a desired value for angle 112 that is smaller than an actual spatial sensitivity of proximity sensor 102.

As shown in FIG. 1, proximity sensor 102 may respond to the presence of an object (not shown in FIG. 1) within sensory range 110 by generating an output signal. The output signal generated by proximity sensor 102 may be galvanic, optical, or wireless (including radio frequency such as the Bluetooth protocol standard), or a combination thereof. The output signal may be provided to controller 106 and/or to another element in portable sensory system 100. It is noted that a sensitivity (or selectivity) of proximity sensor 102 may be exhibited by a difference in response of proximity sensor 102 to objects within sensory range 110 versus to objects that are not within sensory range 110. Proximity sensor 102 may operate using any one or more of different types of transducers (not shown in FIG. 1), such as transducers for detecting photons, acoustic waves, thermal energy, pressure, radio waves, chemical species, or other forms of electromagnetic radiation. Proximity sensor 102 may further be equipped with an emitter or transmitter (not shown in FIG. 1), depending on a desired method of operation of the transducer. Proximity sensor 102 may obtain electrical power from power source 108 and/or from an other source, such as an internal power source (not shown in FIG. 1). Although proximity sensor 102 is shown for clarity in FIG. 1 associated with a single instance of sensory range 110, it is noted that, in certain embodiments, proximity sensor 102 may be configured with multiple channels of sensory range 110 and corresponding output signals. It is further noted that proximity sensor 102 may be implemented in different sizes and/or forms, including miniature, subminiature, microscopic, and nanoscale, among others.

In portable sensory system 100 of FIG. 1, the output signal generated by proximity sensor 102 may be indicative of the presence (or appearance) of an object within sensory range 110. The output signal may further be indicative of additional attributes of the object that are measured by proximity sensor 102. For example, the output signal may be indicative of a distance of the object from proximity sensor 102. Based on the distance measurement, the output signal may be indicative of a velocity and/or acceleration of the object relative to proximity sensor 102. In certain instances, the output signal may be indicative of a size or a physical dimension of the object. For example, the output signal may be indicative of a shape or form (e.g., round, square, pointed, etc.) of the object. In still other embodiments, the output signal may be indicative of a physical property of the object, such as, but not limited to, density, hardness, strength, reflectivity, color, material composition, or physical state (i.e., solid, liquid, gas, or plasma), or other material property.

Also shown in FIG. 1 are haptic actuator 104 and acoustic output 105, which are depicted in an exemplary arrangement in portable sensory system 100 coupled to controller 106. It is noted that haptic actuator 104 and/or acoustic output 105 may represent at least one sensory actuator configured to provide sensory feedback to a user of portable sensory system 100. Haptic actuator 104 may be any of a variety of actuators configured to apply forces, vibrations, and/or motions to generate a mechanical stimulation. In portable sensory system 100, haptic actuator 104 may be activated in response to the output signal generated by proximity sensor 102, as discussed above. The mechanical stimulation may be communicated to the user via the user's sense of touch. For example, haptic actuator 104 may be positioned to be in communication with a particular portion of the user's body (i.e., the user's skin). Furthermore, a characteristic of the mechanical stimulation may be varied to convey specific information to the user. For example, the mechanical stimulation may be applied using a code (e.g., Morse code) to represent alphanumeric characters, and thus, textual language expressions. In certain embodiments, the characteristic of the mechanical stimulation may be varied in response to a measurement (i.e., output signal) provided by proximity sensor 102. For example, when haptic actuator 104 is configured for vibration, a frequency and/or magnitude of the vibration may be used to convey information about the detected object, such as a distance of the object from proximity sensor 102, or a size of the object, etc. In this manner, haptic actuator 104 may be used to provide intuitive sensory feedback to the user about objects in the user's environs. Acoustic output 105 may be any of a variety of acoustic output devices that can generate auditory signals. For example, acoustic output 105 may represent a buzzer, a loudspeaker, a tone generator, a ringer, or other acoustic output device. As described above with respect to the mechanical stimulation generated by haptic actuator, the auditory signals generated by acoustic output 105 may be varied to convey specific information to the user, including information about the detected object and about the user's environs. Although example implementations of portable sensory systems and portable sensory devices are described herein including haptic actuators for clarity, it is noted that, in various embodiments, acoustic output 105 may be used in conjunction with or as a substitute for haptic actuator 104.

In FIG. 1, haptic actuator 104 and acoustic output 105 are shown for clarity as singular elements that are associated with sensory range 110. In particular embodiments, multiple instances of haptic actuator 104 and acoustic output 105 may be respectively associated with multiple instances of sensory range 110, which may be provided by one or more instances of proximity sensor 102, as mentioned previously. In some embodiments, haptic actuator 104 and/or acoustic output 105 may be configured to respond with a specific mechanical stimulation or auditory signal that is associated (e.g., coded) with a particular instance of sensory range 110. In this manner, a single instance of haptic actuator 104 and/or acoustic output 105 may be associated with one or more instances of sensory range 110, while providing mechanical stimulation or auditory signaling that is correlated to a specific instance of sensory range 110. It is further noted that haptic actuator 104 and/or acoustic output 105 may be implemented in different sizes and/or forms, including miniature, subminiature, microscopic, and nanoscale, among others.

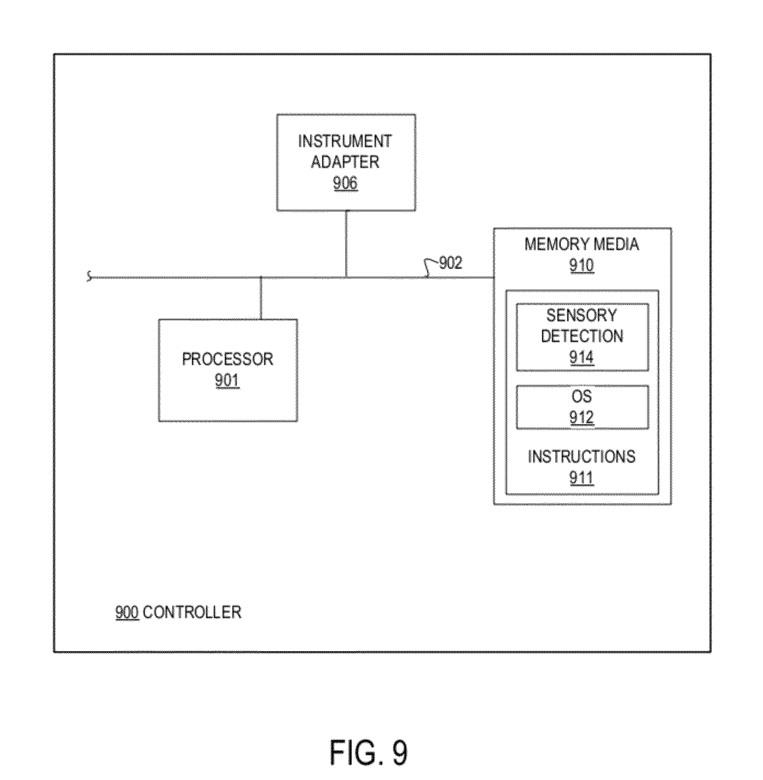

Additionally in FIG. 1, controller 106 is shown as a central element, and in particular, in communication with proximity sensor 102 and haptic actuator 104 and/or acoustic output 105. As indicated above, controller 106 may represent elements of portable sensory system 100 that form a control circuit (not shown in FIG. 1) that is coupled to at least proximity sensor 102 and haptic actuator 104 and/or acoustic output 105. In one embodiment, controller 106 may represent an interconnection element for coupling proximity sensor 102 with haptic actuator 104 and acoustic output 105. Controller 106 may further route electrical power from power source 108 to proximity sensor 102 and haptic actuator 104 and/or acoustic output 105. Controller 106 may still further provide connections for enabling operation of switch 120. In particular embodiments, controller 106 may include instrumentation elements for enabling operation of proximity sensor 102 and/or haptic actuator 104 and/or acoustic output 105, such as, but not limited to, amplifiers, signal interfaces, power converters, receivers, transceivers, wireless interfaces, etc. In some embodiments, controller 106 may include processing functionality to execute stored instructions to perform the methods described herein (see also FIG. 9), including communicating with proximity sensor 102 and/or haptic actuator 104 and/or acoustic output 105. For example, based on the output signal received from proximity sensor 102, controller 106 may be configured to determine a suitable control signal for haptic actuator 104 and/or acoustic output 105, such that haptic actuator 104 and/or acoustic output 105 generates the specific mechanical stimulation or auditory signal (as applicable) corresponding to the output signal received from proximity sensor 102. The control signal for haptic actuator 104 provided by controller 106 may be a command message that is interpreted and executed by haptic actuator 104. Likewise, the control signal for acoustic output 105 provided by controller 106 may be a command message that is interpreted and executed by acoustic output 105. It is noted that controller 106 may be implemented in different sizes and/or forms, including miniature, subminiature, microscopic, and nanoscale, among others.

Also shown in FIG. 1 is power source 108, which may represent an internal or external source of electrical power for operating portable sensory system 100. In one embodiment, power source 108 may represent an electrical battery, comprised of one or more cells in a variety of form factors. The electrical battery may be replaceable and/or may be rechargeable. In certain embodiments, power source 108 may further include connectivity to an external power source (not shown in FIG. 1), such as a solar cell, a thermal-power cell, or a power distribution network. For example, power source 108 may include a transceiver for obtaining power from wireless signals, such as radio-frequency or microwave signals, or a type of capacitor configured to receive and store energy, such as static electricity, generated by the user of portable sensory system 100. In some embodiments, power source 108 includes a combination of a rechargeable energy storage element (such as the electrical battery mentioned above) and an energy input, such that portable sensory system 100 is configured for a certain degree of autonomous operation, while retaining the ability to tap into an external power source for recharging the energy storage element. Power source 108 may route electrical power to various elements in portable sensory system 100 via controller 106 or directly (not explicitly shown in FIG. 1).

FIG. 1 is further shown including switch 120, which may represent a control element that can be operated by the user. Switch 120 may represent a mechanical or electrical component for allowing the user to select/deselect operation of certain elements in portable sensory system 100. For example, switch 120 may be operable to activate/deactivate at least one of haptic actuator 104 and acoustic output 105, which may start/stop operation of portable sensory system 100, at least as perceived by the user. Switch 120 may further be coupled to other elements depicted in portable sensory system 100 via controller 106, and may be used to activate/deactivate other elements, in addition to, or instead of, haptic actuator 104 and/or acoustic output 105. It is noted that switch 120 may be linked via a galvanic, optical, or wireless connection.

In operation of portable sensory system 100 depicted in FIG. 1, a user may activate at least one of haptic actuator 104 and acoustic output 105 by operating switch 120. Proximity sensor 102 may then sense the presence of an object (not shown in FIG. 1) within sensory range 110, and generate an output signal in response thereto. Proximity sensor 102 may further measure a distance to the object, or a size of the object, for example, and convey the measured values using the output signal. Controller 106 may receive the output signal from proximity sensor 102, and in response, may generate a control signal for haptic actuator 104 and/or acoustic output 105. As noted above, in certain embodiments, at least a portion of the functionality of controller 106 is performed using interconnection circuitry between proximity sensor 102 and haptic actuator 104 and/or acoustic output 105. The control signal may be received by haptic actuator 104 and/or acoustic output 105, which may in response, generate a mechanical stimulation or auditory signal that is perceptible by the user. The mechanical stimulation and/or auditory signal may convey to the user that an object is presently within sensory range 110. The mechanical stimulation and/or auditory signal may further be varied (in terms of amplitude, frequency, or a combination thereof) according to a property of the object, such as size, proximity distance, velocity, color, shape, materials, etc., as mentioned previously. In this manner, sensory information representing visual information may be provided to the user in tactile form.

In given embodiments, certain elements in portable sensory system 100 of FIG. 1 may represent a sensory subsystem. For example, a proximity sensor 102/haptic actuator 104 pair may be associated with a given instance of sensory range 110. In other instances, a proximity sensor 102/acoustic output 105 pair may be associated with a given instance of sensory range 110. As will be described in further detail herein, portable sensory system 100 may be integrated into a portable device that is carried and/or worn by the user, such as an item of clothing. The portable device may include multiple instances of the sensory subsystem, corresponding to different instances of sensory range 110. The different instances of sensory range 110 may be oriented to allow for perception of objects from different directions, which may be conveyed to the user through corresponding instances of haptic actuator 104 and/or acoustic output 105, and/or through specific mechanical stimulations by haptic actuator 104 and/or through specific auditory signals by acoustic output 105 that are individually associated with specific instances of sensory range 110.

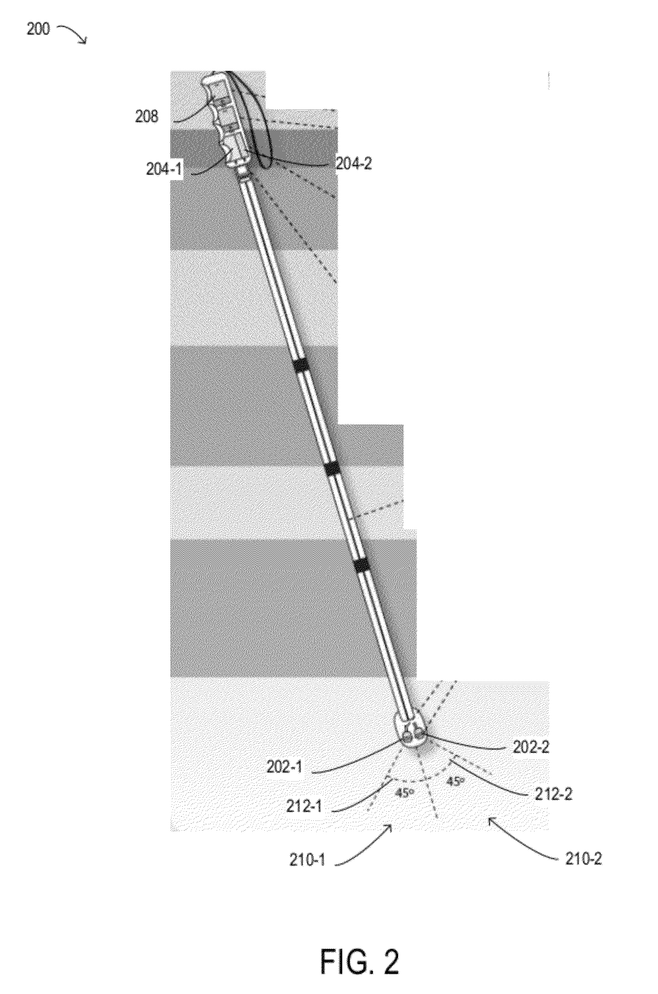

Referring to FIG. 2, a block diagram of selected elements of an embodiment of portable sensory device 200 is illustrated. Portable sensory device 200 may include various elements described above with respect to portable sensory system 100 (see FIG. 1). Portable sensory device 200 is provided in the form of a novel walking cane, which may be externally similar in form to a conventional walking cane commonly used by visually impaired users. Portable sensory device 200 may include proximity sensors 202-1, 202-2, which may respectively provide object detection within sensory ranges 210-1, 210-2, which, in turn, subtend respective angles 212-1, 212-2. Portable sensory device 200 may further include haptic actuators 204-1, 204-2, along with power supply 208. In portable sensory device 200, a first sensory subsystem may be represented by proximity sensor 202-1 and haptic actuator 204-1, corresponding to right-side sensory range 210-1. A second sensory subsystem may be represented by proximity sensor 202-2 and haptic actuator 204-2, corresponding to left-side sensory range 210-2. The first and second sensory subsystems may further include a controller, either individual or shared (not shown in FIG. 2). In operation, a user may hold portable sensory device 200 at a handle portion where respective haptic actuators 204-1, 204-2 are installed. When an object within right-side sensory range 210-1 is detected by proximity sensor 202-1, haptic actuator 204-1 may be activated and generate a right-side mechanical stimulation that is perceptible by the user. The user may interpret the right-side mechanical stimulation as an indication of a right-side object. Similarly, when an object within left-side sensory range 210-2 is detected by proximity sensor 202-2, haptic actuator 204-2 may be activated and generate a left-side mechanical stimulation that is perceptible by the user. The user may interpret the left-side mechanical stimulation as an indication of a left-side object. It is noted that, while portable sensory device 200 is described in terms of a haptic actuator to provide user feedback, any of a variety of sensory actuators, such as acoustic output 105 (see FIG. 1), may be substituted for or used along with the haptic actuator.

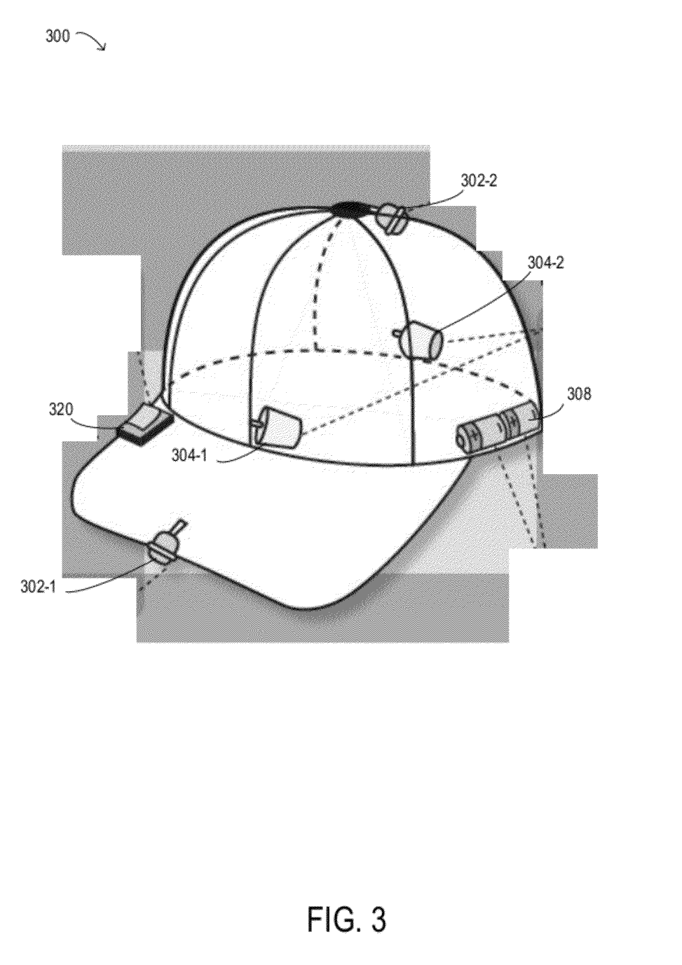

Turning now to FIG. 3, a block diagram of selected elements of an embodiment of portable sensory device 300 is illustrated. Portable sensory device 300 may include various elements described above with respect to portable sensory system 100 (see FIG. 1). Portable sensory device 300 is provided in the form of a novel hat, which may be externally similar in form to conventional hats worn by visually impaired users. Portable sensory device 300 may include proximity sensors 302-1, 302-2, which may respectively provide object detection within individual sensory ranges (not shown in FIG. 3). For example, proximity sensor 302-1 may provide a front sensory range, while proximity sensor 302-2 may provide a rear sensory range. Portable sensory device 300 may further include haptic actuators 304-1, 304-2, along with power supply 308 and switch 320. In portable sensory device 300, a first sensory subsystem may be represented by proximity sensor 302-1 and haptic actuator 304-1, corresponding to a front sensory range. A second sensory subsystem may be represented by proximity sensor 302-2 and haptic actuator 304-2, corresponding to a rear sensory range. The first and second sensory subsystems may further include a controller, either individual or shared (not shown in FIG. 3). In operation, a user may activate portable sensory device 300 using switch 320 while wearing portable sensory device 300. Haptic actuators 304-1, 304-2 may be installed for perception by the user at a respective forehead and rear head position. When an object within the front sensory range is detected by proximity sensor 302-1, haptic actuator 304-1 may be activated and generate a front mechanical stimulation that is perceptible by the user. The user may interpret the front mechanical stimulation as an indication of an object approaching from the front. Similarly, when an object within the rear sensory range is detected by proximity sensor 302-2, haptic actuator 304-2 may be activated and generate a rear mechanical stimulation that is perceptible by the user. The user may interpret the rear mechanical stimulation as an indication of an object behind the user. It is noted that, while portable sensory device 300 is described in terms of a haptic actuator to provide user feedback, any of a variety of sensory actuators, such as acoustic output 105 (see FIG. 1), may be substituted for or used along with the haptic actuator.

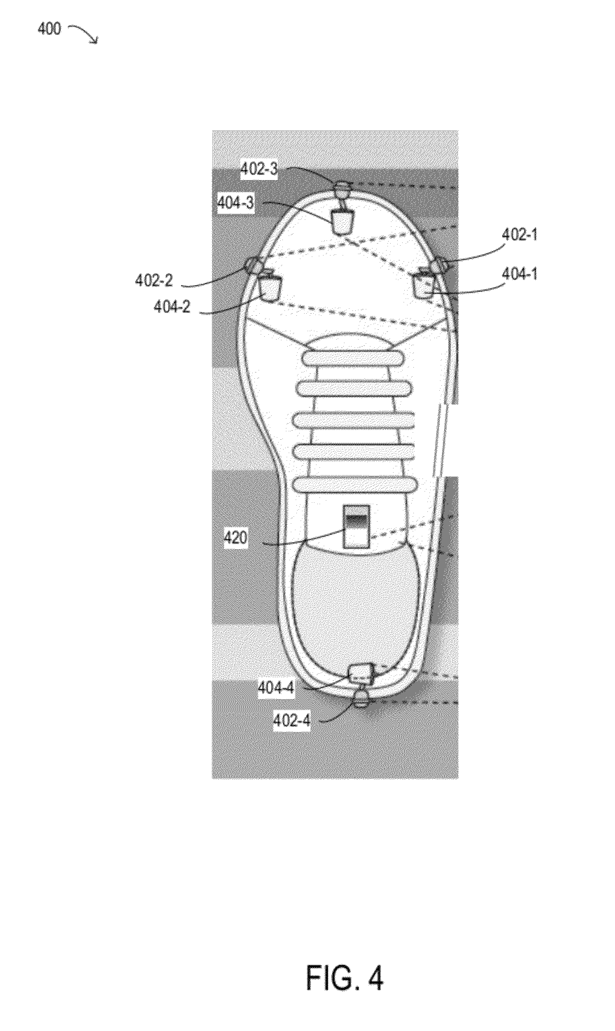

Turning now to FIG. 4, a block diagram of selected elements of an embodiment of portable sensory device 400 is illustrated. Portable sensory device 400 may include various elements described above with respect to portable sensory system 100 (see FIG. 1). Portable sensory device 400 is provided in the form of a novel shoe, which may be externally similar in form to a conventional shoe worn by visually impaired users. Although only a right-shoe embodiment is shown in FIG. 4 for clarity, it will be understood that portable sensory device 400 may be implemented in a left shoe (not shown in FIG. 4). Portable sensory device 400 may include proximity sensors 402-1, 402-2, 402-3, 402-4, which may respectively provide object detection within individual sensory ranges (not shown in FIG. 4). For example, proximity sensor 402-1 may provide a right-side sensory range, proximity sensor 402-2 may provide a left-side sensory range, proximity sensor 402-3 may provide a front sensory range, while proximity sensor 402-4 may provide a rear sensory range. Portable sensory device 400 may further include haptic actuators 404-1, 404-2, 404-3, 404-4, along with a power supply (not shown in FIG. 4) and switch 420. In portable sensory device 400, a first sensory subsystem may be represented by proximity sensor 402-1 and haptic actuator 404-1, corresponding to a right-side sensory range. A second sensory subsystem may be represented by proximity sensor 402-2 and haptic actuator 404-2, corresponding to a left-side sensory range. A third sensory subsystem may be represented by proximity sensor 402-3 and haptic actuator 404-3, corresponding to a front sensory range. A fourth sensory subsystem may be represented by proximity sensor 402-4 and haptic actuator 404-4, corresponding to a rear sensory range. The first, second, third, and fourth sensory subsystems may further include a controller, either individual or shared (not shown in FIG. 4). In operation, a user may activate portable sensory device 400 using switch 420 while wearing portable sensory device 400. Haptic actuators 404-1, 404-2, 404-3, 404-4 may be installed for perception by the user at respective right, left, front and rear foot positions. When an object within the right-side sensory range is detected by proximity sensor 402-1, haptic actuator 404-1 may be activated and generate a right-side mechanical stimulation that is perceptible by the user. The user may interpret the right-side mechanical stimulation as an indication of a right-side object. Similarly, when an object within the left-side sensory range is detected by proximity sensor 402-2, haptic actuator 404-2 may be activated and generate a left-side mechanical stimulation that is perceptible by the user. The user may interpret the left-side mechanical stimulation as an indication of a left-side object. When an object within the front sensory range is detected by proximity sensor 402-3, haptic actuator 404-3 may be activated and generate a front mechanical stimulation that is perceptible by the user. The user may interpret the front mechanical stimulation as an indication of an object approaching from the front. Similarly, when an object within the rear sensory range is detected by proximity sensor 402-4, haptic actuator 404-4 may be activated and generate a rear mechanical stimulation that is perceptible by the user. The user may interpret the rear mechanical stimulation as an indication of an object behind the user. It is noted that, while portable sensory device 400 is described in terms of a haptic actuator to provide user feedback, any of a variety of sensory actuators, such as acoustic output 105 (see FIG. 1), may be substituted for or used along with the haptic actuator.

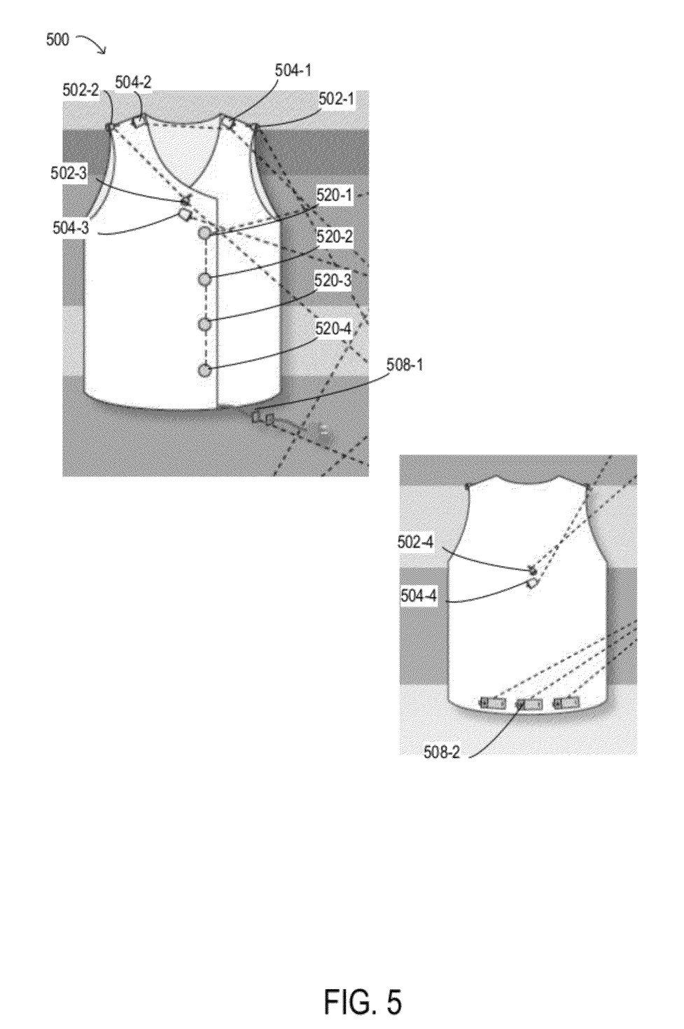

Turning now to FIG. 5, a block diagram of selected elements of an embodiment of portable sensory device 500 is illustrated. Portable sensory device 500 may include various elements described above with respect to portable sensory system 100 (see FIG. 1). Portable sensory device 500 is provided in the form of a novel vest (shown in FIG. 1 from a front view and a rear view), which may be externally similar in form to a conventional vest worn by visually impaired users. Portable sensory device 500 may include proximity sensors 502-1, 502-2, 502-3, 502-4, which may respectively provide object detection within individual sensory ranges (not shown in FIG. 5). For example, proximity sensor 502-1 may provide a left-side sensory range, proximity sensor 502-2 may provide a right-side sensory range, proximity sensor 502-3 may provide a front sensory range, while proximity sensor 502-4 may provide a rear sensory range. Portable sensory device 500 may further include haptic actuators 504-1, 504-2, 504-3, 504-4, along with power supply 508-1, 508-2 and switches 520-1, 520-2, 520-3, 520-4. In portable sensory device 500, a first sensory subsystem may be represented by proximity sensor 502-1 and haptic actuator 504-1, corresponding to a left-side sensory range. A second sensory subsystem may be represented by proximity sensor 502-2 and haptic actuator 504-2, corresponding to a right-side sensory range. A third sensory subsystem may be represented by proximity sensor 502-3 and haptic actuator 504-3, corresponding to a front sensory range. A fourth sensory subsystem may be represented by proximity sensor 502-4 and haptic actuator 504-4, corresponding to a rear sensory range. The first, second, third, and fourth sensory subsystems may further include a controller, either individual or shared (not shown in FIG. 5). Power supply 508-1 may be used to connect an external power supply, for example, for recharging power supply 508-2, which may represent an internal battery pack. In operation, a user may activate portable sensory device 500 using respective switches 520-1, 520-2, 520-3, 520-4 to individually active the first, second, third, and fourth sensory subsystems, while wearing portable sensory device 500. Haptic actuators 504-1, 504-2, 504-3, 504-4 may be installed for perception by the user at respective right, left, front and rear positions. When an object within the left-side sensory range is detected by proximity sensor 502-1, haptic actuator 504-1 may be activated and generate a left-side mechanical stimulation that is perceptible by the user. The user may interpret the left-side mechanical stimulation as an indication of a left-side object. Similarly, when an object within the right-side sensory range is detected by proximity sensor 502-2, haptic actuator 504-2 may be activated and generate a right-side mechanical stimulation that is perceptible by the user. The user may interpret the right-side mechanical stimulation as an indication of a right-side object. When an object within the front sensory range is detected by proximity sensor 502-3, haptic actuator 504-3 may be activated and generate a front mechanical stimulation that is perceptible by the user. The user may interpret the front mechanical stimulation as an indication of an object approaching from the front. Similarly, when an object within the rear sensory range is detected by proximity sensor 502-4, haptic actuator 504-4 may be activated and generate a rear mechanical stimulation that is perceptible by the user. The user may interpret the rear mechanical stimulation as an indication of an object behind the user. It is noted that, while portable sensory device 500 is described in terms of a haptic actuator to provide user feedback, any of a variety of sensory actuators, such as acoustic output 105 (see FIG. 1), may be substituted for or used along with the haptic actuator.

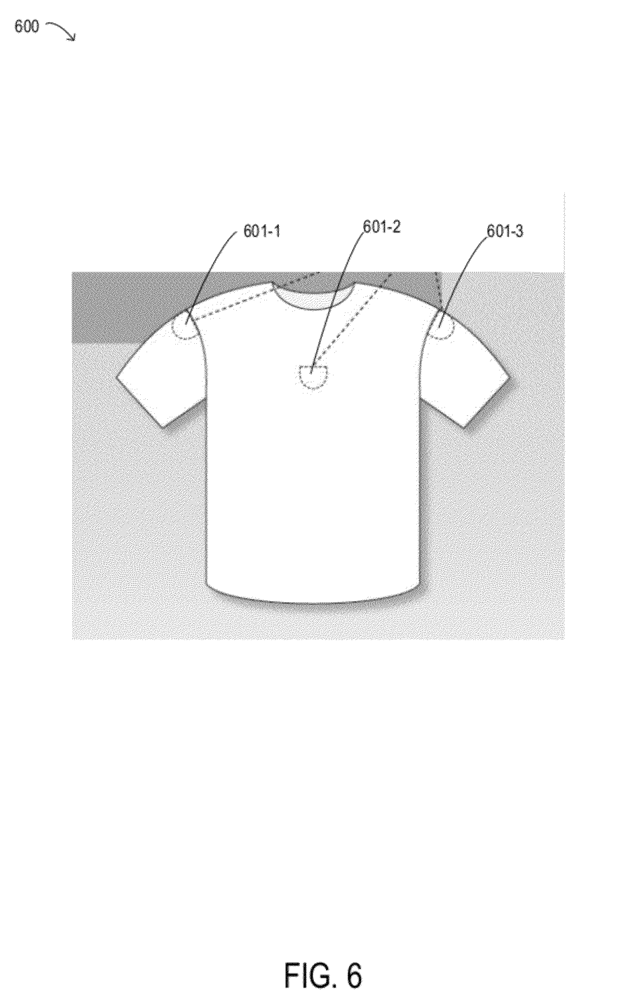

Turning now to FIG. 6, a block diagram of selected elements of an embodiment of t-shirt 600 is illustrated. T-shirt 600 is configured to attach components of a portable sensory device, such as various elements described above with respect to portable sensory system 100 (see FIG. 1). T-shirt 600 with integrated portable sensory device(s) may be externally similar in form to a conventional t-shirt worn by visually impaired users. Specifically, t-shirt 600 may be equipped with sensory device compartments 601-1, 601-2, 601-3 that are suitable for inclusion of components of a portable sensory device, such as proximity sensors and haptic actuators and acoustic outputs, as described previously herein.

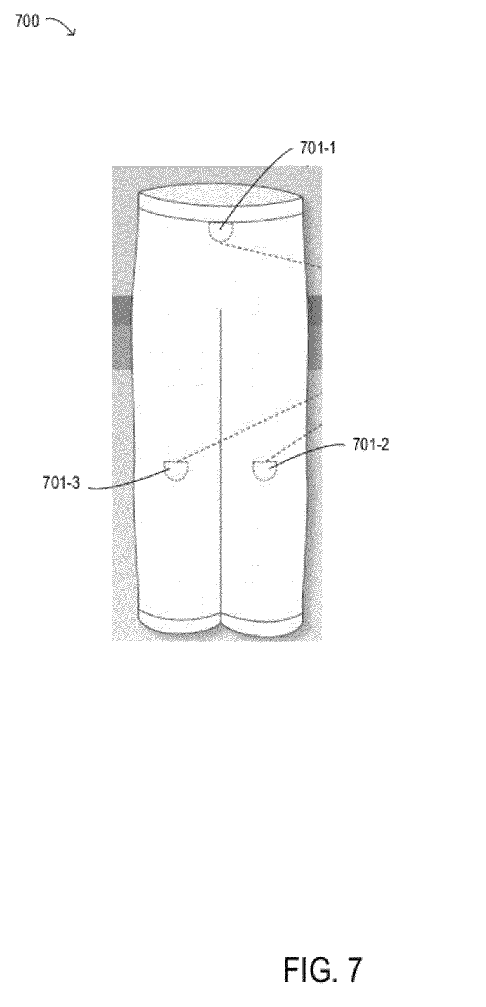

Turning now to FIG. 7, a block diagram of selected elements of an embodiment of pants 700 is illustrated. Pants 700 are configured to attach components of a portable sensory device, such as various elements described above with respect to portable sensory system 100 (see FIG. 1). Pants 700 with integrated portable sensory device(s) may be externally similar in form to conventional pants worn by visually impaired users. Specifically, pants 700 may be equipped with sensory device compartments 701-1, 701-2, 701-3 that are suitable for inclusion of components of a portable sensory device, such as proximity sensors and haptic actuators and acoustic outputs, as described previously herein.

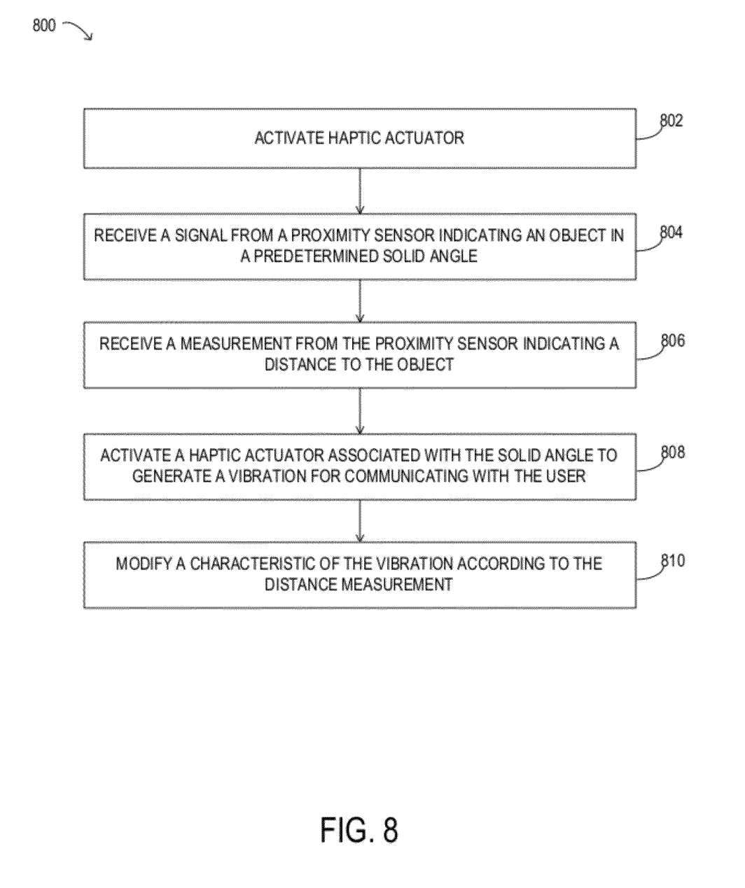

Turning now to FIG. 8, a block diagram of selected elements of an embodiment of method 800 for communicating sensory information to a user is depicted in flow-chart form. Method 800 may be executed by an embodiment of portable sensory system 100 or an embodiment of a portable sensory device incorporating portable sensory system 100. In particular embodiments, certain portions of method 800 may be executed by an embodiment of controller 106 (see also FIG. 9). It is noted that, while method 800 is described in terms of a haptic actuator to provide user feedback, any of a variety of sensory actuators, such as acoustic output 105 (see FIG. 1), may be substituted for or used along with the haptic actuator. It is further noted, that in the case of acoustic output 105, in the auditory signal may include a code specific to the solid angle. A characteristic of the signal may be modified according to the distance measurement (operation 810 below). The characteristic may be volume, an amplitude, a frequency, or a combination thereof.

In method 800, a haptic actuator may be activated (operation 802). Operation 802 may be performed in the context of activation of certain portions of, or all of a portable sensory device including a haptic actuator, such as described by portable sensory system 100 (see FIG. 1). Activating the haptic actuator may be performed in response to a user operating a switch of a portable sensory device, as described previously. A signal may be received from a proximity sensor indicating an object in a predetermined solid angle (operation 804). The solid angle may define a sensory range of the proximity sensor. A measurement indicating a distance to the object may be received from the proximity sensor (operation 806). A haptic actuator associated with the solid angle may be activated to generate a vibration for communicating with the user (operation 808). The haptic actuator may provide a mechanical excitation associated with the sensory range of the proximity sensor. In certain instances, the vibration may include a code specific to the solid angle. A characteristic of the vibration may be modified according to the distance measurement (operation 810). The characteristic may be an amplitude, a frequency, or a combination thereof.

Referring now to FIG. 9, a block diagram illustrating selected elements of an embodiment of controller 900 for communicating sensory information to a user of a portable sensory device is depicted. Controller 900 may represent an embodiment of controller 106 (see FIG. 1). In the embodiment depicted in FIG. 9, controller 900 includes processor 901 coupled via shared bus 902 to storage media collectively identified as memory media 910.

Controller 900, as depicted in FIG. 9, further includes instrument adapter 906 that interfaces controller 900 to sensors, transducers, actuators, and/or signal processing equipment. In one example, instrument adapter 906 may be configured to provide connectivity for proximity sensor 102 and/or haptic actuator 104 and/or acoustic output 105 (see FIG. 1).

Memory media 910 encompasses persistent and volatile media, fixed and removable media, and magnetic and semiconductor media. Memory media 910 is operable to store instructions, data, or both. Memory media 910 as shown includes sets or sequences of instructions 911, namely, an operating system 912 and sensory detection 914. Operating system 912 may be a UNIX or UNIX-like operating system, a Windows® family operating system, or another suitable operating system. In certain embodiments, sensory detection 914 may execute at least some operations for portable sensory communication, such as portions of method 800 described above (see FIG. 8).

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for communicating sensory information to a user, comprising:
receiving a signal from a proximity sensor indicating an object in a predetermined sensory range of the proximity sensor; and
responsive to receiving the signal, activating a haptic actuator associated with the predetermined sensory range;
wherein the proximity sensor and the haptic actuator are contained in a portable object.

2. The method of claim 1, wherein the portable object is a walking cane.

3. The method of claim 1, wherein the portable object is an item of clothing worn by the user.

4. The method of claim 1, wherein the sensory range is given by a first solid angle with respect to the proximity sensor.

5. The method of claim 4, wherein the proximity sensor and the haptic actuator comprise a first sensory subsystem associated with the first solid angle, and wherein the portable object contains a second sensory subsystem associated with a second solid angle different from the first solid angle.

6. The method of claim 1, wherein the haptic actuator is configured to communicate with the user by generating a vibratory stimulation.

7. The method of claim 6, wherein the vibratory stimulation is indicative of the predetermined sensory range.

8. The method of claim 6, wherein the proximity sensor is configured to measure a distance from the object to the proximity sensor, and further comprising:
varying a characteristic of the vibratory stimulation in response to the measured distance.

9. The method of claim 8, wherein the characteristic of the vibratory stimulation is at least one of: an amplitude and a frequency.

10. The method of claim 1, wherein the portable object is configured for attachment to an item of clothing worn by the user.

11. A portable system for communicating sensory information, comprising:
at least two sensory subsystems, wherein each sensory subsystem further comprises:
a controller;
a proximity sensor configured to detect an object within a predetermined solid angle with respect to the proximity sensor; and
a haptic actuator, and
wherein the controller is configured to:
responsive to receiving a signal from the proximity sensor indicating the detected object, activate the haptic actuator.

12. The portable system of claim 11, wherein each of the at least two sensory subsystems is configured to detect an object in a different solid angle.

13. The portable system of claim 11, wherein the portable system is configured for attachment to an item of clothing worn by a user.

14. The portable system of claim 11, wherein the controller comprises a control circuit coupled to the proximity sensor and the haptic actuator.

15. The portable system of claim 14, further comprising:
a switch coupled to the control circuit and configured to activate or deactivate at least the haptic actuator.

16. The portable system of claim 11, wherein the haptic actuator is configured to generate a vibratory stimulation.

17. The portable system of claim 16, wherein the proximity sensor is configured to measure a distance of the detected object, and wherein the controller is further configured to:
vary a characteristic of the vibratory stimulation according to the distance of the object from the proximity sensor.

18. The portable system of claim 17, wherein the characteristic of the vibratory stimulation is at least one of: an amplitude and a frequency.

19. The portable system of claim 18, wherein the portable system is configured for attachment to an item of clothing worn by a user.

20. A portable sensory device, comprising:
a controller;
a proximity sensor configured to detect an object within a predetermined solid angle with respect to the proximity sensor; and
a sensory actuator;
wherein the controller is configured to:
responsive to receiving a signal from the proximity sensor indicating the detected object, activate the sensory actuator.

21. The portable sensory device of claim 20, wherein the controller comprises a control circuit coupled to the proximity sensor and the sensory actuator, and, further comprising:
a switch coupled to the control circuit and configured to activate or deactivate at least the sensory actuator.

22. The portable sensory device of claim 20, wherein the sensory actuator is an acoustic output configured to generate an auditory signal, and wherein the proximity sensor is configured to measure a physical property of the detected object.

23. The portable sensory device of claim 22, wherein the controller is further configured to:
vary a characteristic of the auditory signal according to the physical property.

24. The portable sensory device of claim 23, wherein the characteristic of the auditory signal is at least one of: an amplitude, a duration, an interval, a volume, and a frequency.

25. The portable sensory device of claim 24, wherein the physical property includes at least one of: a distance of the object from the proximity sensor, a color of the object, a physical dimension of the object, a shape of the object, a material included in the object, and a relative motion of the object with respect to the proximity sensor.

26. The portable sensory device of claim 20, wherein the portable sensory device is configured for attachment to an item of clothing worn by a user.

27. The portable sensory device of claim 20, wherein the portable sensory device is included in an item of clothing worn by a user.

28. The portable sensory device of claim 20, wherein the sensory actuator is a haptic actuator device configured to generate vibratory stimulations.
